(19) United States
(12) Patent Application Publication
(10) Pub. No.: US 2022/0173920 A1
(43) Pub. Date: Jun. 2, 2022

(54) ACTIVE MEDIA FEED SELECTION FOR VIRTUAL COLLABORATION

(71) Applicant: Hewlett-Packard Development Company, L.P., Spring, TX (US)

(72) Inventor: Sook Min Park, Palo Alto, CA (US)

(73) Assignee: Hewlett-Packard Development Company, L.P., Spring, TX (US)

(21) Appl. No.: 17/600,141

(22) PCT Filed: Jul. 25, 2019
(86) PCT No.: PCT/US2019/043332

§ 371 Date: Sep. 30, 2021

(51) Int. Cl. H04L 12/18; G06F 11/34

(52) U.S. Cl. CPC H04L 12/1831; G06F 11/3438; H04L 12/1822

(57) ABSTRACT

A system to select an active media feed from a media stream for a virtual meeting. The system includes audio-video recording equipment to capture an audio-video feed of a meeting place to contribute to a media stream. The system further includes a graphical display device to generate a graphical image feed to contribute to the media stream. The system further includes a set of instructions to monitor the media stream to detect activity in the audio-video feed and the graphical image feed, select an active media feed from the media stream based on activity detected in the media stream, and output the active media feed to a display.

### BACKGROUND

Virtual collaboration systems aim to enable groups of people to meet and collaborate with remote collaborators over the internet as effectively as if they were meeting together in person. Such systems typically include a set of cameras, microphones, speakers, and displays setup at a physical meeting place to record people speaking and otherwise participating in the meeting. Remote collaborators may participate in the meeting using a remote computing device, which may include a camera, microphone, speaker, and display, or other devices which enable the remote collaborator to interact with the collaborators at the meeting place. Thus, a virtual meeting may be established that simulates the remote collaborators meeting with the other collaborators in-person directly at the meeting place.

The virtual meeting may be facilitated by a host computing device located at a physical meeting place that routes information to and from the various devices connected to the virtual meeting. Such a host computing device may include a user interface with which collaborators at the meeting place may interact to initiate the virtual meeting, end the virtual meeting, and transmit a whiteboard or shared screen from the host computing device.

### BRIEF DESCRIPTION OF THE DRAWINGS

FIG. 1 is a schematic diagram of an example system to select an active media feed for dissemination through a virtual meeting.

FIG. 2 depicts another example system to select an active media feed for dissemination through a virtual meeting.

FIG. 3 is a schematic diagram depicting example relative activity levels of different devices contributing media feeds to a media stream of a virtual meeting.

FIG. 4 is a schematic diagram of an example computing device to select an active media feed for dissemination through a virtual meeting.

FIG. 5 is a schematic diagram of an example non-transitory machine-readable storage medium. The storage medium stores instructions to cause a processor of a computing device to select an active media feed for dissemination through a virtual meeting.

FIG. 6 is a flowchart of an example method to select an active media feed for dissemination through a virtual meeting.

### DETAILED DESCRIPTION

A host computing device that facilitates a virtual meeting may manage several different media feeds from different media sources participating in the virtual meeting. The several different media feeds may together be referred to as a media stream. For example, a media stream may include an audio-video feed captured by audio-video equipment located at a physical meeting place or graphical image feed generating by a whiteboarding device operated by one of the collaborators at the meeting place or a screenshare from a remote computing device controlled by one of the remote collaborators. These media feeds may be disseminated through the virtual meeting to collaborator devices and play as audio, video, an image, or another media form, as appropriate. A collaborator device may be a computing device that a collaborator uses to participate in the virtual meeting or a media device like a speaker or a display that is used to play media disseminated through the virtual meeting.

In some virtual collaboration systems, several media feeds may be made available to a collaborator device, which the collaborator may choose to view simultaneously or individually by manual selection. In other systems, a centralized controller may select one or a subset of the different media feeds to be played at the collaborator devices, or prioritized for playback at the collaborator devices, based on prioritization criteria. In some systems, a centralized controller may emphasize playback of one of the media feeds in relation to the other media feeds based on prioritization criteria.

Some virtual collaboration systems may intelligently select one audio-video feed of a person speaking to be played, or emphasized, over another audio-video feed which does not contain a person speaking, or according to another prioritization criteria that is meant to give prioritized playback to the most appropriate media feed at any given time. However, when a graphical image feed, such as a whiteboard drawing or a screen share, is introduced to the media stream, control over whether the graphical image feed is displayed, or emphasized, over any of the audio-video feeds, is typically determined manually. Thus, a fluid conversation taking place over a virtual meeting may be disrupted by the display of a graphical image feed.

A virtual collaboration system may be provided which selects an active media feed from a media stream to be disseminated to collaborator devices based on activity detected in the media stream. Selection of the active feed may be based on prioritization criteria, which may prioritize a media feed of a person speaking, or a graphical user interface being used, according to a set of rules. Thus, a virtual collaboration system may fluidly transition between displaying an audio-video feed and displaying a graphical image feed without the need for manual control, and without the graphical image feed interrupting the fluidity of conversation.

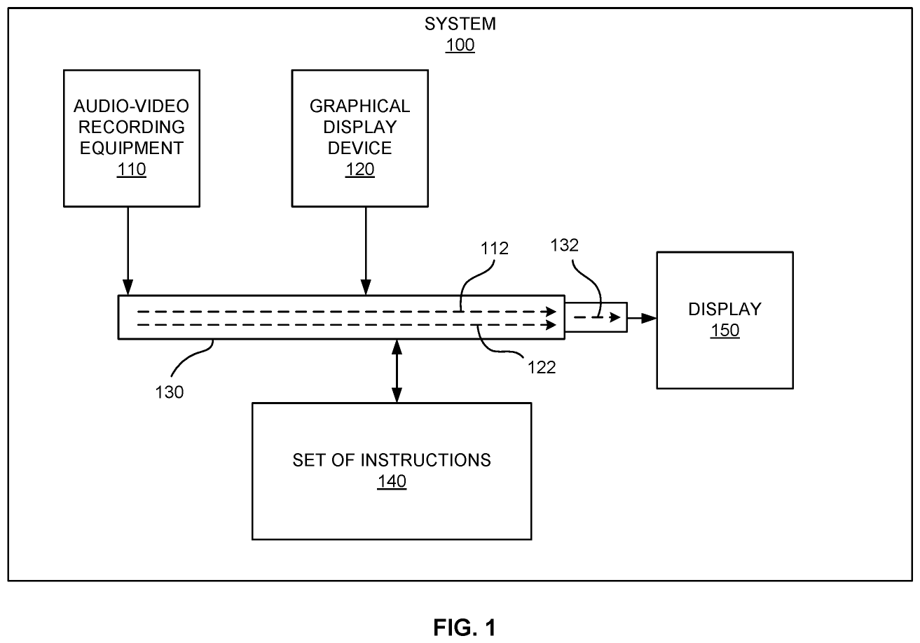

FIG. 1 is a schematic diagram of an example system 100 to select an active media feed 132 for dissemination through a virtual meeting. The system 100 includes audio-video recording equipment 110 to capture an audio-video feed 112 of a meeting place to contribute to a media stream 130. The audio-video recording equipment 110 may include a camera to record video and a microphone to record audio. The audio-video recording equipment 110 may be positioned to capture collaborators speaking at the meeting place. Further, the audio-video recording equipment 110 may include actuators and controllers with instructions to detect activity, such as a person speaking, at the meeting place, and to focus capture of the audio-video feed 112 at the activity.

The system 100 further includes a graphical display device 120 to generate a graphical image feed 122 to contribute to the media stream 130. The graphical display device 120 may include a personal computing device, tablet, whiteboarding device, or any other device capable of generating and transmitting a graphical image feed. The graphical image feed 122 may include a screenshare, a drawing, a video, or any other feed of graphical imagery.

The system 100 further includes a set of instructions 140 to select an active media feed 132 from the media stream 130 for dissemination through the virtual meeting. The set of instructions may be stored in a non-transitory machine-readable storage medium, and may be executed by a processor of a computing device. The set of instructions 140 may be executed by a computing device, including a personal computing device, a host computing device located at the meeting place, a remote server, a cloud computing network, or any other computing device with access to the media stream 130. The system 100 further includes a display 150 to which the active media feed 132 is transmitted.

The set of instructions 140 is to monitor the media stream 130 to detect activity in the audio-video feed 112 and the graphical image feed 122. The set of instructions 140 is further to select an active media feed 132 from the media stream 130 based on activity detected in the media stream 130. Further, the set of instructions is to output the active media feed 132 to the display 150.

Activity detected in a media feed may refer to a change in visual appearance, the detection of sound, user interaction, or any other perceptible change of media in a media feed. Thus, the set of instructions 140 may further be able to detect change in the graphical image feed or the audio-video feed and to count the change as activity. For the audio-video feed 112, activity generally includes motion or sound captured by the audio-video recording equipment 110. In some examples, a person speaking may be counted as activity, and thus the set of instructions 140 may further be able to detect a person speaking in the audio-video feed 112 and to count the person speaking as activity. The set of instructions 140 may further include instructions to quantify the activity. The set of instructions 140 may further include instructions to filter minor activity from being counted as activity in the audio-video feed 112.

Further, for the graphical image feed 122, activity generally includes streaming of a video, movement of objects on a screen, or the drawing or editing of an image. In some examples, the graphical display device 120 may include an input device to draw or edit an image in the graphical image feed 122, and such input may be counted as activity. Thus, the set of instructions 140 may further be able to detect such input and to count the input as activity. The set of instructions 140 may further include instructions to quantify the activity. The set of instructions 140 may further include instructions to filter minor activity from being counted as activity in the graphical image feed 122.

When there is activity detected in multiple media feeds substantially simultaneously, the set of instructions 140 may include instructions to select the active media feed 132 based on prioritization criteria. The prioritization criteria may include rules to assign activity levels to each of the media feeds based on the activity detected therein and to select the media feed with the highest activity level as the active media feed 132. The activity levels may be relative activity levels or absolute activity levels. An activity level may be measured in arbitrary units. The activity levels may be normalized so that different media feeds of different media types may be compared. For example, activity detected in media feeds containing audio-video content and activity detected in media feeds containing graphical image content may be compared according to the same activity level units. Thus, criteria may be evaluated to select the active media feed 132 from media feeds containing different media types.

Thus, the set of instructions 140 may further be able to assign an activity level for the audio-video feed 112 based on activity detected in the audio-video feed 112, and assign an activity level for the graphical image feed 122 based on activity detected in the graphical image feed 122. Further, the set of instructions 140 may include instructions to select the audio-video feed 112 as the active media feed 132 if the activity level for the audio-video feed 112 is greater than the activity level for the graphic image feed 122, and select the graphical image feed 122 as the active media feed 132 if the activity level for the graphical image feed 122 is greater than the activity level for the audio-video feed 112. In this way, each media feed competes to be selected as the active media feed 132. Assigning a level of activity to a media feed may involve quantitative analysis, qualitative analysis, or a combination of such, of each media feed, and different analysis may be conducted to the different types of media feeds.

The set of instructions 140 may include additional prioritization instructions to select the active media feed 132 based on additional criteria, such as a timestamp of when activity was detected or a type of media feed. Thus, for example, the set of instructions 140 may include instructions to record a timestamp for detected activity and to prioritize more recent activity in the media stream over less recent activity. As another example, the set of instructions 140 may include instructions to prioritize activity of a device that receives direct user manipulation, such as a mouse, keyboard, or whiteboard device.

In other words, where the analysis of the media feeds involves quantitative analysis, the set of instructions 140 may further be able to quantify activity detected in the audio-video feed 112 and the graphical image feed 122, compare a quantity of activity detected in the audio-video feed 112 versus a quantity of activity detected in the graphical image feed 122 to determine a most active feed, and prioritize the most active feed for selection as the active media feed 132. The set of instructions 140 may modify quantification of activity detected in a media feed based on prioritization criteria. Such prioritization criteria may be preconfigured or may be configured by a user having access to control the virtual meeting.

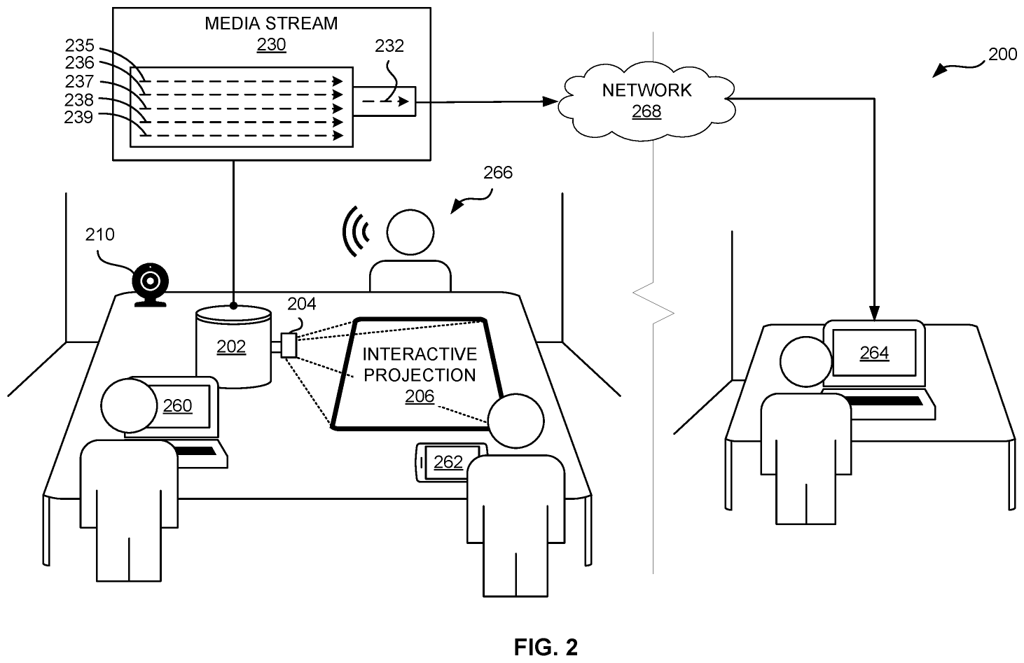

FIG. 2 depicts another example system 200 to select an active media feed 232 for dissemination through a virtual meeting. The system 200 includes a host computing device 202 which is to facilitate a virtual meeting among collaborator devices in which some collaborator devices are located at a meeting place and other collaborator devices are remote from the meeting place. The host computing device 202 is to receive media feeds from different media sources which together may be referred to as a media stream 230. The host computing device 202 is to select an active media feed 232 from the media stream 230 and transmit the active media feed 232 to the collaborator devices. Such a collaborator device may include a media device, such as a speaker or display, or a computing device, whether located at the meeting place or remote from the meeting place.

The system 200 further includes collaborator devices to participate in the virtual meeting, including a laptop computer 260 controlled by a collaborator at the meeting place, a smartphone 262 controlled by a collaborator at the meeting place, and a remote computing device 264 controlled by a remote collaborator. Each of the additional computing devices may contribute a media feed to the media stream 230 of the virtual meeting and receive the active media feed 232. The host computing device 202 may transmit the active media feed 232 to the remote computing device 264 via a computing network indicated as network 268.

The system 200 further includes a camera 210 to capture audio and video at the meeting place. The camera 210 may be positioned to capture a collaborator speaking 266 at the meeting place. Further, the camera 210 may include actuators and controllers with instructions to detect activity, such as a person speaking, at the meeting place, and to focus capture of audio and video of the activity.

The host computing device 202 further includes a graphical display device 204, which includes a projector to project an interactive projection 206 onto a surface, such as a table, at the meeting place, and a camera to record user interaction with the interactive projection 206. A collaborator may interact with the interactive projection 206 to draw, edit, or otherwise manipulate an image thereon. Thus, the interactive projection 206 may function similar to a whiteboarding device on which a collaborator may draw or manipulate an image. The host computing device 202 further includes instructions to detect user interaction with the interactive projection 206 and to count user interaction with the interactive projection 206 as activity.

Thus, the camera 210 contributes an audio-video feed 235, which includes audio and video captured at the meeting place, to the media stream 230. The laptop computer 260 contributes a graphical image feed 236, which may include a screen share, to the media stream 230. Smartphone 262 contributes a graphical image feed 237, which may include a screen share, to the media stream 230. Remote computing device 264 contributes a graphical image feed 238, which may include a screen share, to the media stream 230. Graphical display device 204 contributes graphical image feed 239, which may include images of the interactive projection 206, to the media stream 230. The host computing device 202 is to select the active media feed 232 from the media feeds 235, 236, 237, 238, and 239.

The host computing device 202 may select the active media feed 232 based on instructions similar to the set of instructions 140 of FIG. 1, and thus, for description of how the host computing device 202 selects the active media feed 232, the description of the set of instructions 140 of FIG. 1 may be referenced. For example, the host computing device 202 may prioritize the graphical image feed 239 containing user manipulation of the interactive projection 206 for selection as the active media feed 232 there is activity on the interactive projection 206.

The host computing device 202 may further include instructions to generate a copy of a portion of the active media feed 232 and to transmit the copy to a user device. Thus, any of the laptop computer 260, smartphone 262, and remote computing device 264 may obtain an image or video transmitted through the media stream 230 for storage.

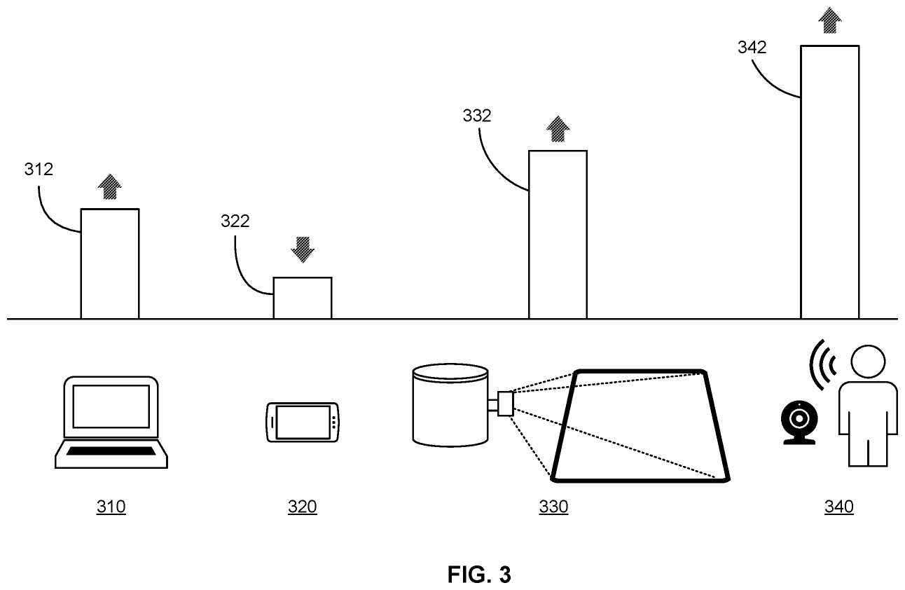

FIG. 3 is a schematic diagram depicting example relative activity levels of different devices contributing media feeds to a media stream of a virtual meeting. The diagram depicts activity levels of collaborator devices participating in a virtual meeting similar to the collaborator devices of the system 200 of FIG. 2. The collaborator devices include a laptop computer 310 to contribute a media feed 312 of a screenshare to the media stream, a smartphone 320 to contribute a media feed 322 of a screenshare to the media stream, a host computing device 330 to contribute a media feed 332 of an interactive projection to the media stream, and a camera 340 to contribute a media feed 342 of an audio-video feed to the media stream. For further description of these collaborator devices, the description of system 200 of FIG. 2 may be referenced.

The activity levels may be assigned according to a set of instructions that includes prioritization instructions, such as the set of instructions 140 of FIG. 1. For further description of such prioritization instructions, description of the set of instructions 140 of FIG. 1 may be referenced.

Thus, the activity levels depicted indicate that the media feed 342 of the camera 340 may be selected as the active media feed for dissemination through the virtual meeting. As discussed with reference to FIG. 1, selection of the media feed 342 may be modified by other prioritization criteria, such as recency of activity, type of media feed, and other criteria.

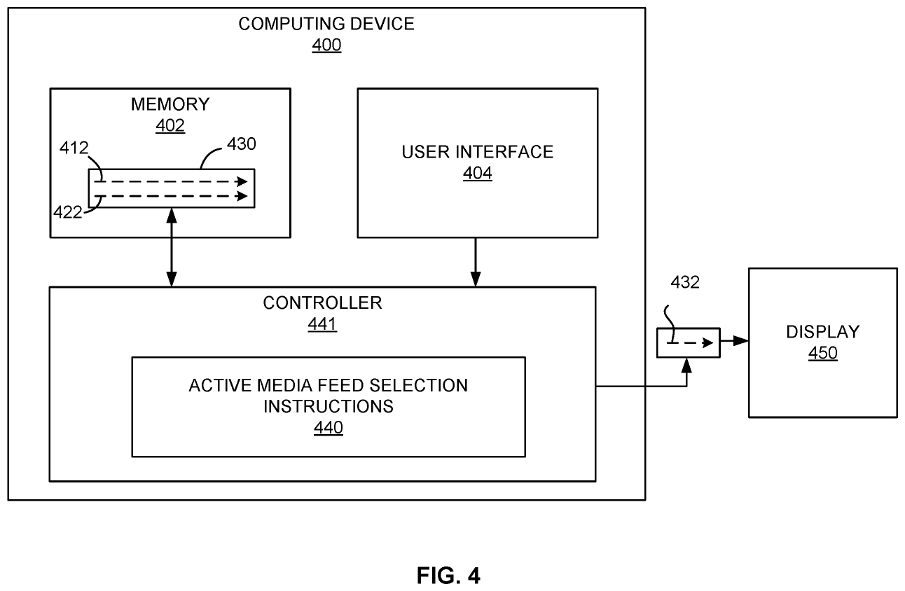

FIG. 4 is a schematic diagram of an example computing device 400 to select an active media feed 432 for dissemination through a virtual meeting. The computing device 400 may be similar to the host computing device 202 of FIG. 2, and thus for further description of the computing device 400, reference may be had to description of the host computing device 202 of FIG. 2.

The computing device 400 includes memory 402 to store a media stream 430. The media stream 430 includes an audio-video feed 412 captured by audio-video equipment at a meeting place and a graphical image feed 422 generated by a graphical display device.

The computing device 400 further includes a user interface 404 to initiate transmission of the active media feed 432 to a display 450. The display 450 may be a display of a remote computing device connected to the virtual meeting. The user interface 404 may include buttons to issue commands to manage the virtual meeting.

The computing device 400 further includes a controller 441 to execute active media feed selection instructions 440 to monitor the media stream 430 to detect activity in the audio-video feed 412 and the graphical image feed 422, and select the active media feed 432 from the media stream 430 based on activity detected in the media stream 430. The active media feed selection instructions 440 may be similar to the set of instructions 140 of FIG. 1, and thus for further description of the active media feed selection instructions 440, reference may be had to the set of instructions 140 of FIG. 1.

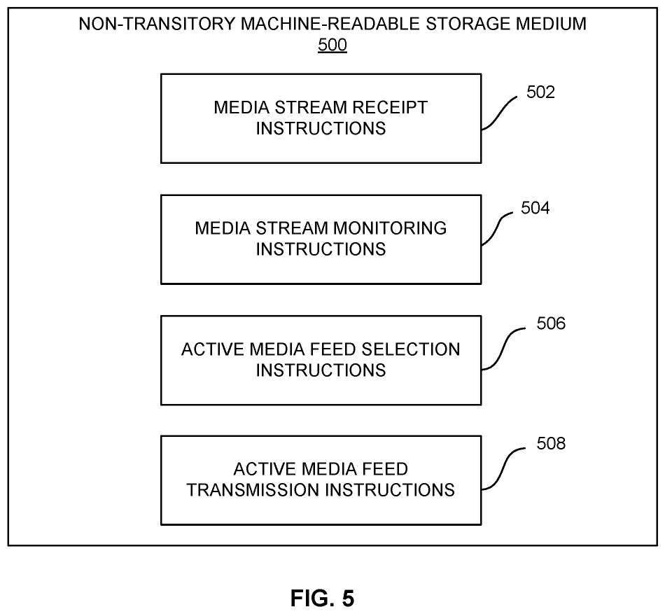

FIG. 5 is a schematic diagram of an example non-transitory machine-readable storage medium 500. The storage medium 500 stores instructions to cause a processor of a computing device to select an active media feed for dissemination through a virtual meeting. The instructions may be similar to the set of instructions 140 of FIG. 1, and thus for further description of the instructions 502, 504, 506, and 508 described below, reference may be had to description of the set of instructions 140 of FIG. 1. Further, such instructions may be executed by a computing device to host a virtual meeting, such as the host computing device 202 of FIG. 2.

The storage medium 500 includes media stream receipt instructions 502 to receive a media stream including an audio-video feed captured by audio-video equipment at a meeting place and a graphical image feed generated by a graphical display device. The storage medium 500 further includes media stream monitoring instructions 504 to monitor the media stream to detect activity. The storage medium 500 further includes active media feed selection instructions 506 to select an active media feed from the media stream based on activity detected in the media stream. The storage medium 500 further includes active media feed transmission instructions 508 to transmit the active media feed to a remote display device remote from the computing device.

The storage medium 500 may include additional prioritization instructions. For example, the storage medium 500 may further include instructions to quantify activity detected in the audio-video feed and the graphical image feed, compare a quantity of activity detected in the audio-video feed versus a quantity of activity detected in the graphical image feed to determine a most active feed, and prioritize the most active feed for selection as the active media feed. The storage medium 500 may further include instructions to prioritize recent activity in the media stream to select the active media feed. Where the graphical display device includes an input device to alter the graphical image feed, the storage medium 500 may further include instructions to detect input to the input device, count the input as activity, and prioritize activity with the input device to select the active media feed.

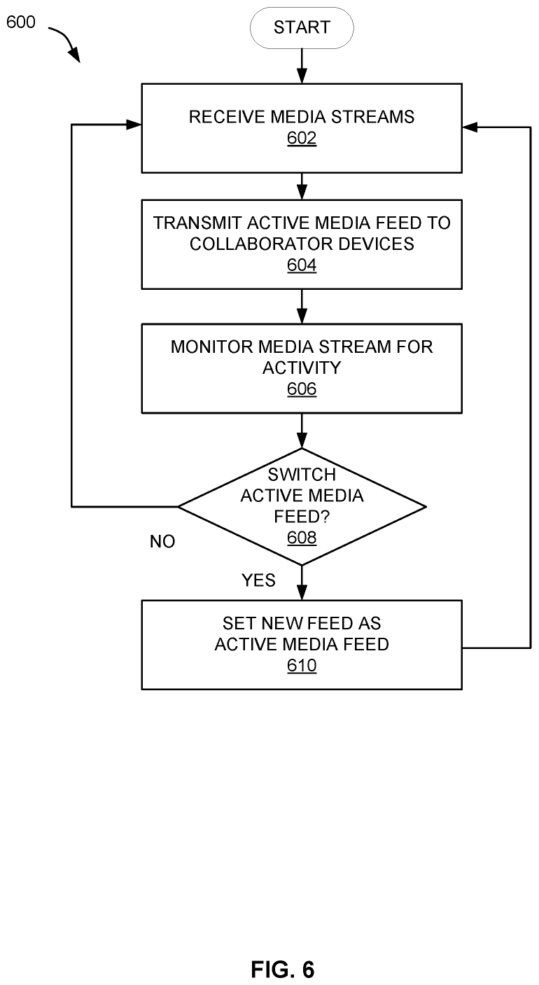

FIG. 6 is a flowchart of an example method 600 to select an active media feed for dissemination through a virtual meeting. The method 600 may be instantiated in instructions stored on a non-transitory machine-readable storage medium and executed by a device or system discussed herein, such as the system 100 of FIG. 1, the system 200 of FIG. 2, or the computing device 400 of FIG. 4. The method 600 may be similar to the set of instructions 140 of FIG. 1, or the instructions stored on the storage medium 500 of FIG. 5, and thus, further description of the method 600 may be had with reference to such elements.

The method 600 is an example of a continuous process for selecting an active media feed. At block 602, at least two media streams are received. At block 604, an active media feed is transmitted to collaborator devices. When no active media feed is currently selected, an initial media feed may be transmitted. At block 606, the media stream is monitored for activity. At block 608, it is determined whether to switch the active media feed to a different media feed. If it is determined that a new active media feed is to be selected, the new active media feed is selected at block 610, and block 602 is repeated. If it is determined that a new active media feed is not to be selected, block 602 is repeated.

Thus, it may be seen that a virtual collaboration system may be provided which selects an active media feed for dissemination to collaborator devices based on activity detected in a media stream. Selection of the active feed may be based on prioritization criteria which enables the virtual collaboration system to fluidly transition between displaying an audio-video feed and a graphical image feed without the need for manual control of the graphical image feed.

It should be recognized that features and aspects of the various examples provided above can be combined into further examples that also fall within the scope of the present disclosure. The scope of the claims should not be limited by the above examples but should be given the broadest interpretation consistent with the description as a whole.

1. A system comprising:
audio-video recording equipment to capture an audio-video feed of a meeting place to contribute to a media stream;
a graphical display device to generate a graphical image feed to contribute to the media stream; and
a set of instructions to:
monitor the media stream to detect activity in the audio-video feed and the graphical image feed;
select an active media feed from the media stream based on activity detected in the media stream; and
output the active media feed to a display.

2. The system of claim 1, wherein the set of instructions is to detect change in the graphical image feed or the audio-video feed and to count the change as activity.

3. The system of claim 1, wherein the graphical display device includes an input device to draw or manipulate an image in the graphical image feed, and the set of instructions is to detect input to the input device and to count the input as activity.

4. The system of claim 1, wherein the set of instructions is to detect a person speaking in the audio-video feed and to count the person speaking as activity.

5. The system of claim 1, wherein the set of instructions is to:
assign an activity level for the audio-video feed based on activity detected in the audio-video feed;
assign an activity level for the graphical image feed based on activity detected in the graphical image feed; and
select the audio-video feed as the active media feed if the activity level for the audio-video feed is greater than the activity level for the graphic image feed, and select the graphical image feed as the active media feed if the activity level for the graphical image feed is greater than the activity level for the audio-video feed.

6. The system of claim 1, wherein:
the graphical display device includes a projector to project an interactive projection onto a surface at the meeting place and a camera to record user interaction with the interactive projection; and
the set of instructions is to detect user interaction with the interactive projection and count user interaction with the interactive projection as activity.

7. The system of claim 6, wherein the interactive projection includes a projection of the graphical image feed.

8. The system of claim 1, wherein the set of instructions is to generate a copy of a portion of the active media feed and to transmit the copy to a user device.

9. A non-transitory machine-readable storage medium comprising instructions that when executed cause a processor of a computing device to:
receive a media stream including an audio-video feed captured by audio-video equipment at a meeting place and a graphical image feed generated by a graphical display device;
monitor the media stream to detect activity;
select an active media feed from the media stream based on activity detected in the media stream; and
transmit the active media feed to a remote display device remote from the computing device.

10. The non-transitory machine-readable storage medium of claim 9, wherein the instructions further cause the processor of the computing device to:
quantify activity detected in the audio-video feed and the graphical image feed;
compare a quantity of activity detected in the audio-video feed versus a quantity of activity detected in the graphical image feed to determine a most active feed; and
prioritize the most active feed for selection as the active media feed.

11. The non-transitory machine-readable storage medium of claim 9, wherein the instructions further cause the processor of the computing device to prioritize recent activity in the media stream to select the active media feed.

12. The non-transitory machine-readable storage medium of claim 9, wherein:
the graphical display device includes an input device to alter the graphical image feed; and
the instructions further cause the processor of the computing device to:
detect input to the input device;
count the input as activity; and
prioritize activity with the input device to select the active media feed.

13. A computing device comprising:
memory to store a media stream, the media stream including an audio-video feed captured by audio-video equipment at a meeting place and a graphical image feed generated by a graphical display device;
a user interface to initiate transmission of an active media feed to a display; and
a controller to execute active media feed selection instructions to:
monitor the media stream to detect activity in the audio-video feed and the graphical image feed; and
select the active media feed from the media stream based on activity detected in the media stream.

14. The computing device of claim 13, wherein:
the computing device includes the graphical display device;
the graphical display device includes a projector to project an interactive projection onto a surface at the meeting place and a camera to record user interaction with the interactive projection; and
the controller is to count user interaction with the interactive projection as activity.

15. The computing device of claim 14, wherein the controller is to prioritize the graphical image feed for selection as the active media feed when the controller counts user interaction with the interactive projection as activity.
